(19) United States
(12) Patent Application Publication
(10) Pub. No.: US 2020/0351328 A1
(43) Pub. Date: Nov. 5, 2020

(54) DATA TRANSMISSION METHOD, DEVICE, EQUIPMENT, AND READABLE STORAGE MEDIUM

(71) Applicants: Beijing Kingsoft Cloud Network Technology Co., Ltd., Beijing (CN); BEIJING KINGSOFT CLOUD TECHNOLOGY CO., LTD., Beijing (CN)

(72) Inventor: Qingyong QIU, Beijing (CN)

(21) Appl. No.: 16/765,146

(22) PCT Filed: Nov. 7, 2018
(86) PCT No.: PCT/CN2018/114393

§ 371 Date: May 20, 2020

(30) Foreign Application Priority Data
Nov. 17, 2017 (CN) 201711153175.6

(51) Int. Cl. H04L 29/08; H04L 29/06; H04L 12/66; H04L 12/46

(52) U.S. Cl. CPC H04L 67/10; H04L 69/329; H04L 12/46; H04L 12/66; H04L 69/16

(57) ABSTRACT

The present application provides a method, an apparatus, a device for transmitting data, and a readable storage medium, and relates to the technical field of cloud computing. The method includes: receiving, by an intranet switch, data from a public network, and determining receiver information for the data according to information contained in the received data; determining a target gateway cluster according to a preset binding relationship between data receivers and gateway clusters; determining a target gateway from the target gateway cluster according to a preset rule; sending the received data to the target gateway, to cause the target gateway to forward the received data to a corresponding data receiver. In the present method, by binding data receivers to gateway clusters in advance, data from the public network can be forwarded to a data receiver by the target gateway in the corresponding target gateway cluster. In this way, gateway clusters with different security levels may be preset in advance according to user requirements, and user data with different security requirements is forwarded through different gateway clusters, which effectively improves the security of data transmission.

### CROSS-REFERENCE TO RELATED APPLICATIONS

This application is a U.S. National-Stage entry under 35 U.S.C. § 371 based on International Application No. PCT/CN2018/114393, filed Nov. 7, 2018 which was published under PCT Article 21(2) and which claims priority to Chinese Application No. 201711153175.6, filed Nov. 17, 2017, which are all hereby incorporated in their entirety by reference.

### TECHNICAL FIELD

This Application pertains to the technical field of cloud computing, and in particular to a method, an apparatus, a device for transmitting data, and a readable storage medium.

### BACKGROUND

Cloud computing is a flexible resource organization and provision method for information technology (referred to as “IT” for short), which can flexibly allocate large-scale server resources and quickly respond to concurrent requests or tasks from a lot of users. Many large multinational companies have already begun to migrate their businesses to cloud computing platforms. Until now, many well-known companies have successively built corresponding cloud computing centers on their own data centers and taken them as main development strategies in the future. Emerging Internet companies are considering turning their attention to public clouds as provided by Amazon, Dropbox, etc., to process their own business. Advantages of high availability, easy expansibility, and low service cost or the like of the cloud computing quickly make it favored by a large number of IT enterprises. However, with the rapid development of cloud computing, along with the development of mobile Internet and big data, higher requirements are inevitably placed on data center networks.

For public cloud or private cloud providers, gateways for data transmission are shared by all users in the network, that is, data from all users may be transmitted through each gateway. If some illegal users deliberately launch attacks to destroy a data forwarding function of a gateway, it is very likely to cause problems such as data leakage or data transmission crash or the like. In addition, other objects, desirable features and characteristics will become apparent from the subsequent summary and detailed description, and the appended claims, taken in conjunction with the accompanying drawings and this background.

### SUMMARY

In view of above, the purpose of the present application is to provide a method, an apparatus, a device for transmitting data, and a readable storage medium, so as to improve the security of data transmission.

In the first aspect, an embodiment of the present application provides a method for transmitting data, which is applied to an intranet switch in a cloud computing network system. The system includes the intranet switch, at least two gateway clusters, and a plurality of data receivers having a binding relationship with the at least two gateway clusters, and each of the gateway clusters includes a plurality of gateways. The method includes: receiving data from a public network, and determining receiver information for the data according to information contained in the received data; determining a target gateway cluster corresponding to the receiver information according to the receiver information and a preset binding relationship between data receivers and gateway clusters; determining a target gateway from the target gateway cluster according to a preset rule; and sending the received data to the target gateway, to cause the target gateway to forward the received data to a data receiver corresponding to the receiver information.

In the second aspect, an embodiment of the present application provides a method for transmitting data which is applied to a cloud host in a cloud computing network system. The system includes an intranet switch, at least two gateway clusters, and a plurality of cloud hosts having a binding relationship with the at least two gateway clusters, and each of the gateway clusters includes a plurality of gateways. The method includes: determining, by a cloud host as a data sender, a target gateway according to a preset binding relationship between data senders and gateway clusters, wherein the target gateway is a gateway in a gateway cluster bound to the cloud host; and sending, by the cloud host, data to the target gateway, to cause the target gateway to send the data to the corresponding intranet switch.

In the third aspect, an embodiment of the present application provides an apparatus for transmitting data which is applied to an intranet switch in a cloud computing network system. The system includes the intranet switch, at least two gateway clusters, and a plurality of data receivers having a binding relationship with the at least two gateway clusters, and each of the gateway clusters includes a plurality of gateways. The apparatus includes: a data receiving module, configured for receiving data from a public network, and determining receiver information for the data according to information contained in the received data; a target gateway cluster determination module, configured for determining a target gateway cluster corresponding to the receiver information according to the receiver information and a preset binding relationship between data receivers and gateway clusters; a target gateway determination module, configured for determining a target gateway from the target gateway cluster according to a preset rule; and a data forwarding module, configured for sending the received data to the target gateway, to cause the target gateway to forward the received data to a data receiver corresponding to the receiver information.

In the fourth aspect, an embodiment of the present application provides an apparatus for transmitting data, which is applied to a cloud host in a cloud computing network system. The system includes an intranet switch, at least two gateway clusters, and a plurality of cloud hosts having a binding relationship with the at least two gateway clusters, and each of the gateway clusters includes a plurality of gateways. The apparatus includes: a gateway determination module, configured for determining a target gateway according to a preset binding relationship between data senders and gateway clusters, wherein the target gateway is a gateway in a gateway cluster bound to the cloud host; and a data sending module, configured for sending data to the target gateway, to cause the target gateway to send the data to the corresponding intranet switch.

In the fifth aspect, an embodiment of the present application provides a readable storage medium for storing a plurality of instructions, wherein the plurality of instructions are executed on a computer to cause the computer to carry out the method for transmitting data according to the first aspect.

In the sixth aspect, an embodiment of the present application provides a readable storage medium for storing a plurality of instructions, wherein the plurality of instructions are executed on a computer to cause the computer to carry out the method for transmitting data according to the second aspect.

In the seventh aspect, an embodiment of the present application provides a device for transmitting data. The device includes a memory and a processor, wherein the memory is configured for storing executable program codes, and the processor is configured for reading the executable program codes stored in the memory to carry out the method for transmitting data according to the first aspect.

In the eighth aspect, an embodiment of the present application provides a device for transmitting data. The device includes a memory and a processor, wherein the memory is configured for storing executable program codes, and the processor is configured for reading the executable program codes stored in the memory to carry out the method for transmitting data according to the second aspect.

In the ninth aspect, a computer program product containing instructions is provided. The product is executed on a computer, to cause the computer to carry out the method for transmitting data according to the first aspect.

In the tenth aspect, a computer program product containing instructions is provided. The product is executed on a computer, to cause the computer to carry out the method for transmitting data according to the second aspect.

In the eleventh aspect, a computer program is provided. The program is executed on a computer, to cause the computer to carry out the method for transmitting data according to the first aspect.

In the twelfth aspect, a computer program is provided. The program is executed on a computer, to cause the computer to carry out the method for transmitting data according to the second aspect.

Embodiments of the present application provide a method, an apparatus, a device for transmitting data, and a readable storage medium. The intranet switch first receives data from a public network, and determines receiver information for the data according to information contained in the received data; determines a target gateway cluster corresponding to the receiver information according to the receiver information and a preset binding relationship between data receivers and gateway clusters; then determines a target gateway from the target gateway cluster according to a preset rule; and then sends the received data to the target gateway to cause the target gateway to forward the received data to a data receiver corresponding to the receiver information. In the present method, by binding cloud hosts and gateway clusters in advance, data from the public network can be forwarded to a data receiver (such as a cloud host) through the target gateway in the corresponding target gateway cluster. In this way, gateway clusters with different security levels can be preset in advance according to user requirements, and user data with different security requirements is forwarded through different gateway clusters, which effectively improves the security of data transmission.

Other features and advantages of the present application will be explained in the following description, and will be partly apparent from the description, or be understood by implementing the embodiments of the present application. The purpose and other advantages of the present application can be achieved and obtained through the structures specifically indicated in the description, claims, and drawings.

### BRIEF DESCRIPTION OF THE DRAWINGS

The present invention will hereinafter be described in conjunction with the following drawing figures, wherein like numerals denote like elements, and

FIG. 1 is a structural diagram of a cloud computing network system according to an embodiment of the present application;

FIG. 2 is a flowchart of a method for transmitting data according to a first embodiment of the present application;

FIG. 3 is a flowchart of a method for transmitting data according to a second embodiment of the present application;

FIG. 4 is a structural block diagram of an apparatus for transmitting data according to a third embodiment of the present application;

FIG. 5 is a structural block diagram of an apparatus for transmitting data according to a fourth embodiment of the present application;

FIG. 6 is a structural diagram of an intranet switch or a host machine according to an embodiment of the present application.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The technical solution of embodiments of the present application will be described clearly and completely below in combination with the drawings of the embodiments of the present application. Obviously, the embodiments described are only some, not all, of the embodiments of the present application. Components of the embodiments of the present application, which are generally described and illustrated in the drawings herein, may be arranged and designed in various different configurations. Therefore, the following detailed description of the embodiments of the present application illustrated in the drawings is not intended to limit the scope of the claimed application, but merely represents selected embodiments of the present application. All other embodiments obtained by those skilled in the art based on the embodiments herein without any creative efforts are within the scope of the present application.

It should be noted that similar reference signs and letters indicate similar items in the following drawings. Thus once an item is defined in one figure, this item is not required to be further defined and explained in subsequent figures. Meanwhile, in the description of the present application, terms such as “first”, “second” and the like are only used to distinguish one element from another element, which should not be understood to indicate or imply their relative importance.

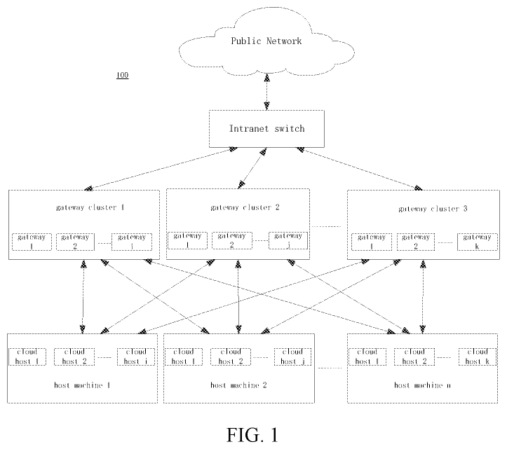

Referring to FIG. 1, FIG. 1 is a structural diagram of a cloud computing network system 100 according to an embodiment of the present application. The system includes an intranet switch, at least two gateway clusters, and a plurality of data receivers having a binding relationship with the at least two gateway clusters. A gateway cluster is composed of a plurality of gateways belonging to this gateway cluster.

The intranet switch is also called an intranet kernel, which is an inlet and outlet in the cloud computing network system 100 for data transmission between a data receiver (such as a cloud host) and a public network.

The gateway is a physical server. In practice, a plurality of gateways may be combined into a gateway cluster as required. One virtual IP address (referred to as “vip” for short) is assigned to gateways in each gateway cluster, that is, each gateway in the gateway cluster corresponds to the same vip, and each gateway in the gateway cluster has its own IP address different from the above vip.

The cloud host is a virtual machine running on a host machine (a physical machine), and a plurality of cloud hosts may run on a host machine.

It can be understood that the structure shown in FIG. 1 is only schematic. All the devices are not directly connected physically, and thus data will pass through other devices during network transmission. For example, a gateway and a host machine may be interconnected via a switch. The cloud computing network system 100 may further include more or fewer components than those shown in FIG. 1, or have a configuration different from that shown in FIG. 1.

### First Embodiment

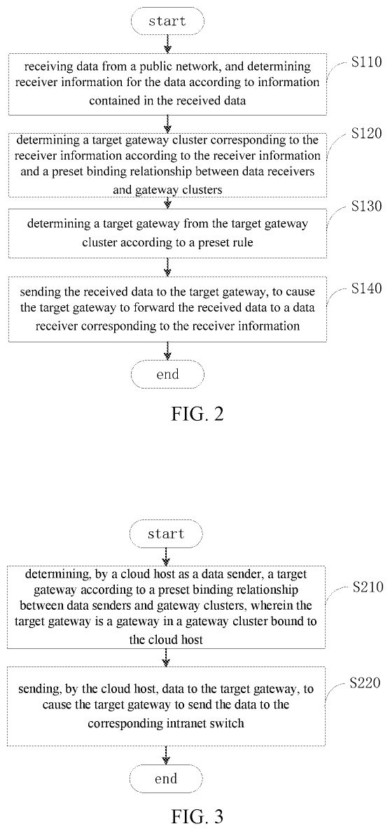

Referring to FIG. 2, FIG. 2 is a flowchart of a method for transmitting data according to the first embodiment of the present application. The method is applicable to the intranet switch of the above cloud computing network system 100. The method includes following steps.

Step S110: receiving data from a public network, and determining receiver information for the data according to information contained in the received data.

In sending, by a public network, data to a data receiver of an intranet in the form of data packets, the data from the public network is first forwarded through the intranet switch. The data packet includes an IP address of the data sender and an IP address of the data receiver, and also includes a media access control (referred to as “MAC” for short) address of the data sender and a MAC address of the data receiver. The intranet switch may forward the data according to the MAC address of the data receiver. After receiving the data, the intranet switch searches stored flow table information, which may be understood as routing information for data transmission. The MAC address and IP address of the data receiver are thus obtained by searching the flow table information, and then the data is forwarded to the data receiver.

It should be noted that the data receiver in the first embodiment of the present application may refer to a cloud host in the intranet.

Step S120: determining a target gateway cluster corresponding to the receiver information according to the receiver information and a preset binding relationship between data receivers and gateway clusters.

After receiving the data, the intranet switch finds, by means of the flow table information, that the data also needs to be sent to a corresponding gateway for forwarding, in order to send the data to the data receiver (such as a cloud host).

In a public cloud or a private cloud, a problem of low data security is caused due to the sharing of gateways by all users. For example, some high-risk users, which may have unknown abnormality packages due to their different business forms, some individual users, blacklisted users, or the like deliberately launch attacks to disable a gateway, which may affect most other users. Therefore, in order to avoid interference caused by data from other users on a public gateway and improve the security of data transmission, all gateways are divided to different gateway clusters in advance, that is, gateway clusters with different security levels are preset in advance, so that user data with different security requirements may be forwarded through a specific gateway cluster to ensure the security of user data transmission. According to actual requirements, a binding relationship between cloud hosts and gateway clusters may be set according to the cloud hosts, and a binding relationship between users and different gateway clusters may be set according to the users. As shown in FIG. 1, an example of setting the binding relationship between users and gateway clusters according to the users is taken. For example, user 1 is host machine 1, and user 2 is host machine 2. All cloud hosts in the host machine 1 are bound to gateway cluster 1, and all cloud hosts in the host machine 2 are bound to gateway cluster 2. Data from the user 1 is transmitted via a corresponding gateway in the gateway cluster 1. Data from the user 2 is transmitted via a corresponding gateway in the gateway cluster 2. Of course, both the user 1 and user 2 may be bound to one gateway cluster, such as gateway cluster 1, thus data from the user 1 and user 2 is transmitted via a corresponding gateway in the gateway cluster 1. An example of setting the binding relationship between cloud hosts and gateway clusters according to the cloud hosts is taken. For example, all cloud hosts in host machine 1 are bound to gateway cluster 1, or a part of cloud hosts in the host machine 1 are bound to the gateway cluster 1, and the remaining of cloud hosts are bound to gateway cluster 2. It should be noted that one cloud host is bound to one gateway cluster, that is, data transmission between this cloud host and the public network is performed through a corresponding gateway in this gateway cluster.

It should be noted that, in the case that the binding relationship between users and gateway clusters is set according to the users, if a user is bound to a target gateway cluster first, in order to prevent gateways of the target gateway cluster from malfunctioning or being congested during work, the user may perform data transmission through a backup gateway cluster. When the gateways of the target gateway cluster malfunction or are congested, the system administrator may modify the binding relationship between users and gateway clusters to make this user be bound to the backup gateway cluster, so that data may be migrated from the target gateway cluster to the backup gateway cluster for transmission.

In an implementation for binding users' cloud hosts to their corresponding gateway clusters in advance, the system also includes a server (not shown in FIG. 1) installed with a Software Defined Network (referred to as “SDN” for short) controller. The SDN controller in the server binds data receivers (cloud hosts) to gateway clusters matched them in advance according to user requirements to obtain the preset binding relationship between data receivers (cloud hosts) and gateway clusters, and then sends the binding relationship to the intranet switch.

If user 1 needs to bind cloud host 1-i to gateway cluster 1, then the cloud host 1-i is bound to gateway 1-i in the gateway cluster 1.

SDN is a new network innovation architecture of Emulex network, and an implementation of network virtualization. Its core technology, OpenFlow, realizes flexible control of network traffic by separating a control plane and data plane of a network device, making the network more smart as a pipeline.

The architecture of SDN is divided into an application layer, a control layer (SDN controller) and a forwarding layer (infrastructure layer), which forwards and controls data based on an OpenFlow protocol. This protocol provides a standard interface to enable the SDN controller and a network switching device (an intranet switch, a gateway, etc.) to communicate with each other.

An SDN forwarding layer software module and an SDN control layer software module are deployed on a gateway, and the gateway transmits data flows in the north-south direction of the SDN network (vertical communication, or external network communication, or communication between the public network and the host in the intranet). Furthermore, there are main components of a series of network virtualization products (such as eip, nat, slb). An SDN forwarding layer software module and an SDN control layer software module are also deployed on a host machine. The SDN forwarding layer software module and the SDN control layer software module are controlled by a server installed with an SDN controller.

The binding process between a cloud host and a gateway cluster is controlled and implemented by the SDN controller. A specific example is taken for illustration. Taking a public cloud product as an example, a user purchases a cloud host and binds the cloud host with an eip. The eip is an elastic IP of the cloud host. The eip may be understood as the IP address of the cloud host. The SDN control layer software modules on the gateway and the host machine are controlled by the SDN controller to generate corresponding configuration information according to the binding relationship between the cloud host and the eip, and the SDN forwarding layer software modules on the gateway and the host machine perform corresponding processes according to the configuration information.

If a user needs to bind his/her cloud host (data receiver) to a gateway cluster, the SDN controller sends the binding relationship to the intranet switch. For example, the eip of a user's cloud host is 120.1.1.1. If the user wants to bind the cloud host to a gateway cluster whose vip is 10.1.1.1, the user may send one configuration instruction to the SDN controller through a control interface of the terminal. The SDN controller automatically configures one piece of mapping information to bind the cloud host to the gateway cluster, such as 120.1.1.1->10.1.1.1, and then sends the configuration information to the intranet switch. All gateways of this gateway cluster are also bound to this cloud host. If the IP of a gateway is 10.124.6.2, the SDN controller automatically configures one piece of mapping information according to the instruction sent by the user through the terminal to bind the cloud host to this gateway, such as 120.1.1.1->10.1.1.1->10.124.6.2. The cloud host may be bound to a plurality of gateways, and each gateway may also be bound to a plurality of cloud hosts. In this way, the SDN controller implements the binding of the cloud host and the corresponding gateway cluster. Furthermore, the SDN controller automatically sends the configuration information to the intranet switch.

For another example, there are two gateways, x1 (10.124.6.2) and x2 (10.124.6.3), and their corresponding vip is: 10.60.0.1. The floating_ip (also referred to as eip, elastic ip, which may be bound/unbound to/from any cloud host) network segment purchased by a public cloud service provider is 120.1.0.0/16. A user sends one instruction to the SDN controller through a relevant interface of a terminal device. The SDN controller issues 120.1.0.0/16 to the x1 and x2, and the configuration instruction is “inet 120.1.0.0/16 scope global dummy0”. The SDN control layer software modules on the gateways x1 and x2 will automatically report their respective routing information to the intranet switch.

The intranet switch can obtain the following information:

10.60.0.1

10.124.6.2:120.1.0.0/16

10.124.6.3:120.1.0.0/16

Thus, a gateway cluster is automatically bound to a cloud host, and the cloud host is automatically bound to a gateway in the gateway cluster, through the SDN controller.

Step S130: determining a target gateway from the target gateway cluster according to a preset rule.

In the process of receiving data by a data receiver (cloud host), if the intranet switch, after receiving the data, finds that the eip of the data receiver (cloud host) is 120.1.1.1 according to the configuration information, the intranet switch sends the data to a corresponding gateway in a gateway cluster (whose vip is 10.1.1.1) bound to the cloud host to forward the data. The gateway cluster is used as the target gateway cluster, and a target gateway is determined from the target gateway cluster for forwarding the data. In the present embodiment, the preset rule refers to a preset classless inter-domain routing (CIDR) longest prefix matching rule, which is to determine a target gateway. Of course, other rules may also be defined. For example, any gateway in the gateway cluster is randomly selected for forwarding data.

CIDR is a method for creating additional addresses on the Internet. These addresses are provided to a service provider (ISP) and then assigned to users by the ISP. CIDR centralizes routings to enable one IP address to represent thousands of IP addresses served by a main backbone provider, thereby reducing the burden of internet routers.

The CIDR longest prefix matching rule refers to IP longest prefix address matching, that is, network number matching. For example, there are two gateways in a gateway cluster. The IP of gateway 1 is 120.10.0.0/16, the IP of gateway 2 is 120.10.20.0/24, and the eip of a cloud host bound to the gateway cluster is 120.10.20.3/24. The network number of gateway 2 is matched with that of the cloud host, and data is thus sent preferably to the gateway 2 for forwarding the data. In case the gateway 2 is unavailable, the gateway 1 is selected for forwarding the data.

Of course, when determining the target gateway through the CIDR longest prefix matching rule, the intranet switch may search for the target gateway by related algorithms, such as a longest prefix matching algorithm based on hash tables, a segmented IP lookup table method based on longest prefix matching, and an Internet protocol version 6 (referred to as “IPV6” for short) longest prefix matching routing lookup algorithm, and so on.

Step S140: sending the received data to the target gateway, to cause the target gateway to forward the received data to a data receiver corresponding to the receiver information.

After determining the target gateway through the above rule, the intranet switch forwards the data to the target gateway, so that the target gateway obtains the MAC address and IP address of a data receiver (cloud host) from the data, and then searches the stored routing information, and sends the data to a data receiver (cloud host) corresponding to the receiver information according to the MAC address of the data receiver (cloud host).

The first embodiment of the present application provides a method for transmitting data. The intranet switch first receives data from a public network, determines receiver information for the data according to information contained in the received data; determines a target gateway cluster according to the receiver information and a preset binding relationship between data receivers and gateway clusters; determines a target gateway from the target gateway cluster according to a preset rule; and then sends the received data to the target gateway to cause the target gateway to forward the received data to a data receiver corresponding to the receiver information. In the present method, by binding data receivers and gateway clusters in advance, data sent from the public network to a data receiver can be forwarded through the target gateway in the corresponding target gateway cluster. In this way, gateway clusters with different security levels can be preset in advance according to user requirements, and user data with different security requirements is forwarded through different gateway clusters, which effectively improves the security of data transmission.

### Second Embodiment

Referring to FIG. 3, FIG. 3 is a flowchart of a method for transmitting data according to the second embodiment of the present application. The method is applicable to a cloud host of the above cloud computing network system 100. The method includes following steps.

Step S210: determining, by a cloud host as a data sender, a target gateway according to a preset binding relationship between data senders and gateway clusters, wherein the target gateway is a gateway in a gateway cluster bound to the cloud host.

When a cloud host sends data to a public network as a data sender, the cloud host needs to be bound to a gateway cluster in advance.

The system also includes a server installed with an SDN controller. The cloud hosts run on a host machine. The preset binding relationship between data senders and gateway clusters is a binding relationship between the cloud hosts and the gateway clusters that are matched with the cloud hosts, which is configured by the SDN controller in the server in advance on the host machine for the cloud hosts according to user requirements.

For example, a user (id 001) has two cloud hosts run on two host machines respectively. Cloud host vm-1 (host machine: HOST1; mac: fa:16:3e:27:a9:e4; fixed ip (fixed_ip): 172.10.1.2; eip: 120.1.1.2). Cloud host vm-2 (host machine: HOST2; mac: fa:16:3e:27:a9:e5; fixed_ip: 172.10.1.3; eip: 120.1.1.7). The user wants to bind the cloud hosts to gateways in a gateway cluster whose vip is 10.60.0.1, and there are two gateways in the gateway cluster, which are x1 (ip of which is 10.124.6.2) and x2 (ip of which is 10.124.6.3) respectively. The user may send an instruction to the SDN controller through a relevant interface of a terminal device, and the SDN controller automatically binds the two cloud hosts to the two gateways respectively. The two gateways automatically configure respective binding information of the cloud hosts and the two gateways thereon. Compute nodes on the host machines configure a route in a data-output-direction. For example, user “vgwadm” configures, through a command “route add”, that an external network request of “0941f7c6-0610-4a56-8088-8c9668660039 intra 0.0.0.0/0” is sent through a gateway with the address of 10.60.0.1. The code may be: vgwadm route add 0941f7c6-0610-4a56-8088-8c9668660039 intra 0.0.0.0/0 gw 10.60.0.1. In sending data to the public network, the cloud host vm-1 selects a target gateway (that is, gateway x1 or gateway x2) according to the CIDR longest prefix matching rule described above, and then sends the data to the target gateway; then, the target gateway sends the data to the intranet switch, and the intranet switch forwards the data to the public network. In the process of transmitting data from the public network to cloud host vm-1, the data is first sent to the intranet switch; the intranet switch forwards the data to the target gateway (gateway x1 or gateway x2); then the target gateway sends the data to the host machine HOST1; and finally the data is sent to the cloud host vm-1.

In addition, the code for gateways is upgraded, and a new gateway x3 with a vip: 10.60.0.2 is expected to be online through gray release. There is an internal text user (id 002), and the eip of his/her cloud host vm-3 is 120.1.3.4. A mapping relationship “002->10.60.0.2” is configured through the SDN controller. The SDN controller automatically configures routing information on the gateway x3: issuing “120.1.3.4-32” to the x3, and the configuration instruction is: inet 120.1.3.4/32 scope global dummy0. The SDN control layer software module on the gateway x3 will automatically report the routing information to the intranet switch. A route “vgwadm route add 9a37ddc8-ad85-4081-9af8-59a629f59c41 intra 0.0.0.0/0 gw 10.60.0.2” is configured on a compute node of a host machine where this cloud host is located. With the above configuration, the user “vgwadm” configures, through the command “route add”, that an external network request of “9a37ddc8-ad85-4081-9af8-59a629f59c41 intra 0.0.0.0/0” is sent through a gateway with the address of 10.60.0.2. Even if then internal user changes, for example, a new cloud host is added or a cloud host is deleted, the gateway x3 will automatically add or delete corresponding configuration. The internal test user uses the gateway x3 that is online though the gray release regardless of the input direction or output direction. In addition, if a senior user wants to monopolize a gateway to avoid scrambling for resources, the user may be bound to a gateway cluster through the SDN controller, thereby reaching the purpose of making a user monopolize a gateway.

Of course, for the specific binding process and the process of determining the target gateway from the target gateway cluster according to a preset rule, reference may be made to the related description in the first embodiment, which is not repeated herein again.

It should be noted that a plurality of cloud hosts may run on a host machine, and at least two cloud hosts among the plurality of cloud hosts are respectively bound to different gateway clusters. Of course, the plurality of cloud hosts may also be bound to one gateway cluster together.

Step S220: sending, by the cloud host, data to the target gateway, to cause the target gateway to send the data to the corresponding intranet switch.

The intranet switch sends the data to the public network according to the flow table information, so that data from the cloud host is forwarded to the intranet switch through the target gateway in the corresponding target gateway cluster, and then forwarded to the public network through the intranet switch.

The second embodiment of the present application provides a method for transmitting data. The cloud host, as a data sender, first determines a target gateway according to a preset binding relationship between data senders and gateway clusters; and then sends data to the target gateway, to cause the target gateway to send the data to the corresponding intranet switch. In the present method, by binding cloud hosts and gateway clusters in advance, data sent from a cloud host to the public network can be forwarded through the target gateway in the corresponding target gateway cluster. In this way, gateway clusters with different security levels can be set in advance according to user requirements, and user data with different security requirements is forwarded through different gateway clusters, which effectively improves the security of data transmission.

### Third Embodiment

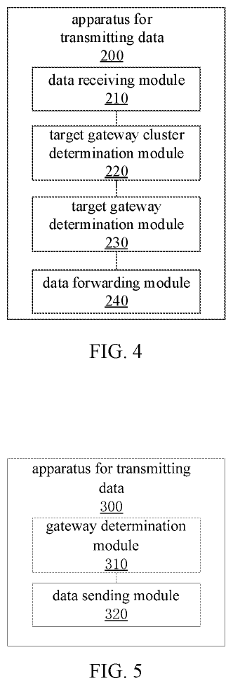

Referring to FIG. 4, FIG. 4 is a structural block diagram of an apparatus for transmitting data 200 according to the third embodiment of the present application. The apparatus is applicable to the above cloud computing network system 100, and runs on an intranet switch. The apparatus includes:

a data receiving module 210, configured for receiving data from a public network, and determining receiver information for the data according to information contained in the received data;

a target gateway cluster determination module 220, configured for determining a target gateway cluster corresponding to the receiver information according to the receiver information and a preset binding relationship between data receivers and gateway clusters;

a target gateway determination module 230, configured for determining a target gateway from the target gateway cluster according to a preset rule;

a data forwarding module 240, configured for sending the received data to the target gateway, to cause the target gateway to forward the received data to a data receiver (a cloud host) corresponding to the receiver information.

As an implementation, the cloud computing network system 100 also includes a server installed with an SDN controller. The preset binding relationship between data receivers and gateway clusters is obtained by binding the data receivers to the gateway clusters that are matched with the data receivers in advance through the SDN controller in the server according to user requirements.

As an implementation, the cloud computing network system 100 also includes a server installed with an SDN controller. The gateway clusters are preset to have different security levels. The preset binding relationship between data receivers and gateway clusters is obtained by binding the data receivers to the gateway clusters that are matched with the data receivers and have corresponding security levers in advance through the SDN controller in the server according to user requirements.

As an implementation, the target gateway determination module 230 is specifically configured for determining the target gateway from the target gateway cluster according to a classless inter-domain routing (CIDR) longest prefix matching rule.

### Fourth Embodiment

Referring to FIG. 5, FIG. 5 is a structural block diagram of an apparatus for transmitting data 300 according to the fourth embodiment of the present application. The apparatus is applicable to the above cloud computing network system 100 and runs on a cloud host. The apparatus includes:

a gateway determination module 310, configured for determining a target gateway according to a preset binding relationship between data senders and gateway clusters, wherein the target gateway is a gateway in a gateway cluster bound to the cloud host;

a data sending module 320, configured for sending data to the target gateway, to cause the target gateway to send the data to the corresponding intranet switch.

As an implementation, the cloud computing network system 100 also includes a server installed with an SDN controller. The cloud hosts run on a host machine. The preset binding relationship between data senders and gateway clusters is a binding relationship between the cloud hosts and the gateway clusters that are matched with the cloud hosts, which is configured by the SDN controller in the server in advance on the host machine for the cloud hosts according to user requirements.

As an implementation, the cloud computing network system 100 also includes a server installed with an SDN controller. The cloud hosts run on a host machine, and the gateway clusters are preset to have different security levels. The preset binding relationship between data senders and gateway clusters is a binding relationship between the cloud hosts and the gateway clusters that are matched with the cloud hosts and have corresponding security levels, which is configured by the SDN controller in the server in advance on the host machine for the cloud hosts according to user requirements.

As an implementation, a plurality of cloud hosts run on a host machine, and at least two cloud hosts among the plurality of cloud hosts are respectively bound to different gateway clusters.

Those skilled in the art may clearly understand that, for the convenience and brevity of the description, the specific working processes of the above apparatus may refer to the corresponding processes in the above method, which are not repeated herein again.

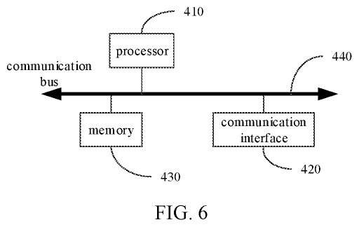

Referring to FIG. 6, FIG. 6 is a structural diagram of an intranet switch or a host machine according to an embodiment of the present application. The intranet switch or host machine may include: at least one processor 410, such as a CPU, at least one communication interface 420, at least one memory 430 and at least one communication bus 440. The communication bus 440 is used to implement direct communication between these components. The communication interface 420 of the device in the embodiment of the present application is used to communicate signals or data with other node devices. The memory 430 may be a high-speed RAM memory or a non-volatile memory, such as at least one magnetic disk memory. The memory 430 may optionally be at least one storage device located away from the processor. A set of program codes is stored in the memory 430, and the processor 410 executes the program codes stored in the memory 430 that is executed by the above intranet switch or host machine, to implement corresponding method processes.

In view of above, embodiments of the present application provide a method, an apparatus, a device for transmitting data, and a readable storage medium. The intranet switch first receives data from a public network, and determines receiver information for the data according to information contained in the received data; determines a target gateway cluster according to a preset binding relationship between data receivers and gateway clusters; then determines a target gateway from the target gateway cluster according to a preset rule; and then sends the received data to the target gateway to cause the target gateway to forward the received data to a data receiver corresponding to the receiver information. In the present method, by binding data receivers and gateway clusters in advance, data from the public network can be forwarded to a data receiver through the target gateway in the corresponding target gateway cluster. In this way, gateway clusters with different security levels can be preset in advance according to user requirements, and user data with different security requirements is forwarded through different gateway clusters, which effectively improves the security of data transmission.

According to several embodiments provided by the present application, it should be understood that the disclosed apparatus and method may also be implemented in other ways. The apparatus embodiments described above are only schematic. For example, the flowcharts and block diagrams in the accompanying drawings show possible architectures, functions, and operations of the apparatuses, methods, and computer program products according to various embodiments of the present application. In this regard, each block in a flowchart or block diagram may represent a module, a program segment, or a part of the codes, which contains one or more executable instructions for implementing a specified logical function. It should also be noted that in some alternative implementations, functions marked in the blocks may also be implemented in a different order than that marked in a drawing. For example, two consecutive blocks may actually be performed substantially in parallel, and they may sometimes be performed in a reverse order, depending on the function involved. It should also be noted that each block in the block diagrams and/or flowcharts, and combinations of blocks in the block diagrams and/or flowcharts, can be implemented with a dedicated hardware-based system that performs specified functions or actions, or can be implemented with a combination of dedicated hardware and computer instructions.

In addition, functional modules in various embodiments of the present application may be integrated together to form an independent part, or each module may exist independently, or two or more modules may be integrated to form an independent part.

If the functions are implemented in the form of software functional modules and sold or used as an independent product, it can be stored in a computer-readable storage medium. Based on this understanding, the technical solution of the present application may be embodied in the form of a software product, or a part that contributes to the prior art or a part of this technical solution may be embodied in the form of a software product. This computer software product is stored in a storage medium, including instructions to cause a computer device (which may be a personal computer, a server, or a network device, etc.) to perform all or part of steps of the methods according to the embodiments of the present application. The above storage medium includes various mediums that can store program codes, such as a U disk, a mobile hard disk, a read-only memory (ROM), a random access memory (RAM), a magnetic disk or an optical disk.

The above are only preferred embodiments of the present application, which are not intended to limit the present application. For those skilled in the art, various modifications and changes can be made to the present application. Any modifications, alternatives, improvements, or the like within the spirit and principle of the present application shall be included within the protection scope of the present application. It should be noted that similar reference signs and letters indicate similar items in the drawings, thus once an item is defined in one figure, this item is not required to be further defined and explained in subsequent figures.

The above are only specific implementations of the present application, and the protection scope of the present application is not limited to this. Within the technical scope disclosed by the present application, any changes or alternatives made by a person skilled in the art easily fall into the protection scope of the present application. Therefore, the protection scope of the present application shall be defined by the claims.

It should be noted that the relationship terms used herein such as “first”, “second”, and the like are only used for distinguishing one entity or operation from another entity or operation, but do not necessarily require or imply that there is any actual relationship or order between these entities or operations. Moreover, the terms “include”, “comprise” or any other variants thereof are intended to cover non-exclusive inclusions, so that processes, methods, articles or devices comprising a series of elements comprise not only those elements listed but also those not specifically listed or the elements intrinsic to these processes, methods, articles, or devices. Without further limitations, elements defined by the sentences “comprise(s) a . . . ” or “include(s) a . . . ” do not exclude that there are other identical elements in the processes, methods, articles, or devices which include these elements.

### INDUSTRIAL APPLICABILITY

The present application provides a method, an apparatus, a device for transmitting data, and a readable storage medium. By binding data receivers to gateway clusters in advance, data from the public network can be forwarded to a data receiver by the target gateway in the corresponding target gateway cluster, which effectively improves the security of data transmission.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A method for transmitting data, applicable to an intranet switch in a cloud computing network system, wherein the system comprises the intranet switch, at least two gateway clusters, and a plurality of data receivers having a binding relationship with the at least two gateway clusters, and each of the gateway clusters comprises a plurality of gateways; wherein the method comprises:
receiving data from a public network, and determining receiver information for the data according to information contained in the received data;
determining a target gateway cluster corresponding to the receiver information according to the receiver information and a preset binding relationship between data receivers and gateway clusters;
determining a target gateway from the target gateway cluster according to a preset rule; and
sending the received data to the target gateway, to cause the target gateway to forward the received data to a data receiver corresponding to the receiver information.

2. The method of claim 1, wherein the system further comprises a server, the method further comprises:
receiving the binding relationship sent by the server, wherein the binding relationship is obtained by binding the data receivers to the gateway clusters that are matched with the data receivers in advance through an SDN controller in the server according to user requirements.

3. The method of claim 1, wherein the system further comprises a server, and the gateway clusters are preset to have different security levels; and
the preset binding relationship between data receivers and gateway clusters is obtained by binding the data receivers to the gateway clusters that are matched with the data receivers and have corresponding security levers in advance through an SDN controller in the server according to user requirements.

4. The method of claim 1, wherein determining a target gateway from the target gateway cluster according to a preset rule comprises:
determining the target gateway from the target gateway cluster according to a classless inter-domain routing (CIDR) longest prefix matching rule.

5. A method for transmitting data, applicable to a cloud host in a cloud computing network system, wherein the system comprises an intranet switch, at least two gateway clusters, and a plurality of cloud hosts having a binding relationship with the at least two gateway clusters, and each of the gateway clusters comprises a plurality of gateways; wherein the method comprises:
determining, by a cloud host as a data sender, a target gateway according to a preset binding relationship between data senders and gateway clusters, wherein the target gateway is a gateway in a gateway cluster bound to the cloud host; and
sending, by the cloud host, data to the target gateway, to cause the target gateway to send the data to the corresponding intranet switch.

6. The method of claim 5, wherein the system further comprises a server, and the cloud hosts run on a host machine; and
the preset binding relationship between data senders and gateway clusters is a binding relationship between the cloud hosts and the gateway clusters that are matched with the cloud hosts, which is configured by an SDN controller in the server in advance on the host machine for the cloud hosts according to user requirements.

7. The method of claim 5, wherein the system further comprises a server, the cloud hosts run on a host machine, and the gateway clusters are preset to have different security levels; and
the preset binding relationship between data senders and gateway clusters is a binding relationship between the cloud hosts and the gateway clusters that are matched with the cloud hosts and have corresponding security levels, which is configured by an SDN controller in the server in advance on the host machine for the cloud hosts according to user requirements.

8. The method of claim 6, wherein the plurality of cloud hosts run on the host machine, and at least two cloud hosts among the plurality of cloud hosts are respectively bound to different gateway clusters.

9. An apparatus for transmitting data, applicable to an intranet switch in a cloud computing network system, wherein the system comprises the intranet switch, at least two gateway clusters, and a plurality of data receivers having a binding relationship with the at least two gateway clusters, and each of the gateway clusters comprises a plurality of gateways, wherein the apparatus comprises:
a data receiving module, configured for receiving data from a public network, and determining receiver information for the data according to information contained in the received data;
a target gateway cluster determination module, configured for determining a target gateway cluster corresponding to the receiver information according to the receiver information and a preset binding relationship between data receivers and gateway clusters;
a target gateway determination module, configured for determining a target gateway from the target gateway cluster according to a preset rule; and
a data forwarding module, configured for sending the received data to the target gateway, to cause the target gateway to forward the received data to a data receiver corresponding to the receiver information.

10. The apparatus of claim 9, wherein the system further comprises a server, and the preset binding relationship between data receivers and gateway clusters is obtained by binding the data receivers to the gateway clusters that are matched with the data receivers in advance through an SDN controller in the server according to user requirements.

11. The apparatus of claim 9, wherein the system further comprises a server, and the gateway clusters are preset to have different security levels; and
the preset binding relationship between data receivers and gateway clusters is obtained by binding the data receivers to the gateway clusters that are matched with the data receivers and have corresponding security levers in advance through an SDN controller in the server according to user requirements.

12. The apparatus of claim 9, wherein the target gateway determination module is further configured for determining the target gateway from the target gateway cluster according to a classless inter-domain routing (CIDR) longest prefix matching rule.

13. An apparatus for transmitting data, applicable to a cloud host in a cloud computing network system, wherein the system comprises an intranet switch, at least two gateway clusters, and a plurality of cloud hosts having a binding relationship with the at least two gateway clusters, and each of the gateway clusters comprises a plurality of gateways; wherein the apparatus comprises:
a gateway determination module, configured for determining a target gateway according to a preset binding relationship between data senders and gateway clusters, wherein the target gateway is a gateway in a gateway cluster bound to the cloud host; and
a data sending module, configured for sending data to the target gateway, to cause the target gateway to send the data to the corresponding intranet switch.

14. The apparatus of claim 13, wherein the system further comprises a server, and the cloud hosts run on a host machine; and
the preset binding relationship between data senders and gateway clusters is a binding relationship between the cloud hosts and the gateway clusters that are matched with the cloud hosts, which is configured by an SDN controller in the server in advance on the host machine for the cloud hosts according to user requirements.

15. The apparatus of claim 13, wherein the system further comprises a server, the cloud hosts run on a host machine, and the gateway clusters are preset to have different security levels; and
the preset binding relationship between data senders and gateway clusters is a binding relationship between the cloud hosts and the gateway clusters that are matched with the cloud hosts and have corresponding security levels, which is configured by an SDN controller in the server in advance on the host machine for the cloud hosts according to user requirements.

16. The apparatus of claim 14, wherein the plurality of cloud hosts run on the host machine, and at least two cloud hosts among the plurality of cloud hosts are respectively bound to different gateway clusters.

17. A non-transitory readable storage medium for storing a plurality of instructions, wherein the plurality of instructions are executed on a computer to cause the computer to carry out the method of claim 1.

18. A non-transitory readable storage medium for storing a plurality of instructions, wherein the plurality of instructions are executed on a computer to cause the computer to carry out the method of claim 5

19. A device for transmitting data, comprising a memory and a processor, wherein the memory is configured for storing executable program codes, and the processor is configured for reading the executable program codes stored in the memory to carry out the method for transmitting data according to claim 1.

20. A device for transmitting data, comprising a memory and a processor, wherein the memory is configured for storing executable program codes, and the processor is configured for reading the executable program codes stored in the memory to carry out the method for transmitting data according to claim 5.
